(19) United States
(12) Patent Application Publication
(10) Pub. No.: US 2024/0255365 A1
(43) Pub. Date: Aug. 1, 2024

(54) LOAD DETECTOR

(71) Applicant: MINEBEA MITSUMI Inc., Nagano (JP)

(72) Inventor: Takuma OKAMOTO, Kitasaku-gun (JP)

(21) Appl. No.: 18/322,702

(22) Filed: May 24, 2023

(30) Foreign Application Priority Data
Jan. 30, 2023 (JP) 2023-011835

(51) Int. Cl. G01L 1/22

(52) U.S. Cl. CPC G01L 1/22

(57) ABSTRACT

To provide a load detector with performance capable of being improved. A load detector 1, 1A includes a flexure element 20, a base part 10 supporting the flexure element 20, at least one strain gauge 24 attached to an inner surface 22a of a flexure part 22 constituting the flexure element 20, and a stopper part 14 attached to the base part 10, receiving the inner surface 22a of the flexure part 22 when the flexure part 22 is deformed, and regulating the deformation of the flexure part 22. A distance D between the stopper part 14 and the inner surface 22a of the flexure part 22 is adjustable.

### CROSS-REFERENCE TO RELATED APPLICATIONS

The present application claims the benefit of Japanese Application No. 2023-11835, filed on Jan. 31, 2023, the entire contents of which are incorporated herein by reference in its entirety.

### BACKGROUND

### Technical Field

The present disclosure relates to a load detector.

### Related Art

For example, JP59-155971A discloses a pressure sensor including a strain gauge formed at the surface of a thin-walled diaphragm. In this pressure sensor, stoppers face the diaphragm at the upper surface and at the bottom surface of the diaphragm, respectively. When an overload acts on the diaphragm, the diaphragm contacts the stopper. As a result, damage to the diaphragm can be avoided because excessive deformation of the diaphragm is prevented.

Smaller loads can be detected as a diaphragm is thinned, but the magnitude of a load allowable by the diaphragm decreases with decreasing thickness. The pressure sensor in Patent Document 1 cannot cope with the increase or decrease of this allowable load. In addition, in general, in order to impart water resistance to a strain gauge, a treatment such as covering the strain gauge with a resin material is required, and this treatment may affect the output of the strain gauge.

An object of the present disclosure is to provide a load detector with performance capable of being improved.

### SUMMARY

A load detector according to a first aspect of the present disclosure includes a flexure element, a base part supporting the flexure element, at least one strain gauge attached to an inner surface of a flexure part constituting the flexure element, and a stopper part attached to the base part, receiving the inner surface of the flexure part when the flexure part is deformed, and regulating the deformation of the flexure part, wherein a distance between the stopper part and the inner surface of the flexure part is adjustable.

A load detector according to a second aspect of the present disclosure includes a flexure element, a base part supporting the flexure element, and at least one strain gauge attached to an inner surface of a flexure part constituting the flexure element, wherein the base part includes an air vent connecting an internal space and an external space, the internal space being formed between the flexure element and the base part, and the air vent is blocked with a film, the film being breathable and waterproof.

According to the present disclosure, a load detector with performance capable of being improved can be provided.

### BRIEF DESCRIPTION OF DRAWINGS

FIG. 1 is a perspective view schematically illustrating the structure of a load detector 1 according to a first embodiment of the present disclosure.

FIG. 2 is an exploded perspective view schematically illustrating the structure of the load detector 1 according to the first embodiment of the present disclosure.

FIG. 3 is a cross-sectional view of the load detector 1 along a line 3-3 in FIG. 1.

FIG. 4 is a plan view schematically illustrating the structure of the load detector 1 according to the first embodiment of the present disclosure.

FIG. 5 is a cross-sectional view of the load detector 1 corresponding to FIG. 3 for illustrating the work of adjusting the position of a stopper part 14.

FIG. 6 is a plan view schematically illustrating the structure of the load detector 1A according to a second embodiment of the present disclosure.

FIG. 7 is a cross-sectional view of a load detector 1A along a line 7-7 in FIG. 6.

### DETAILED DESCRIPTION

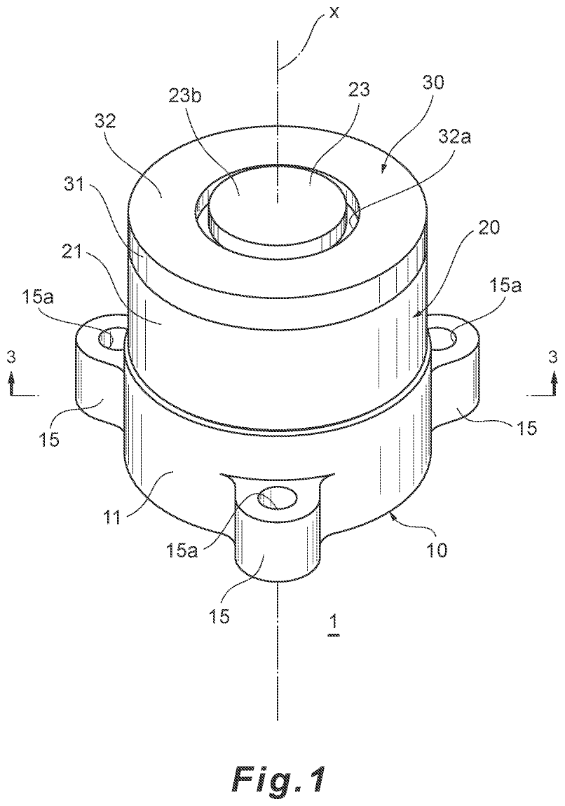

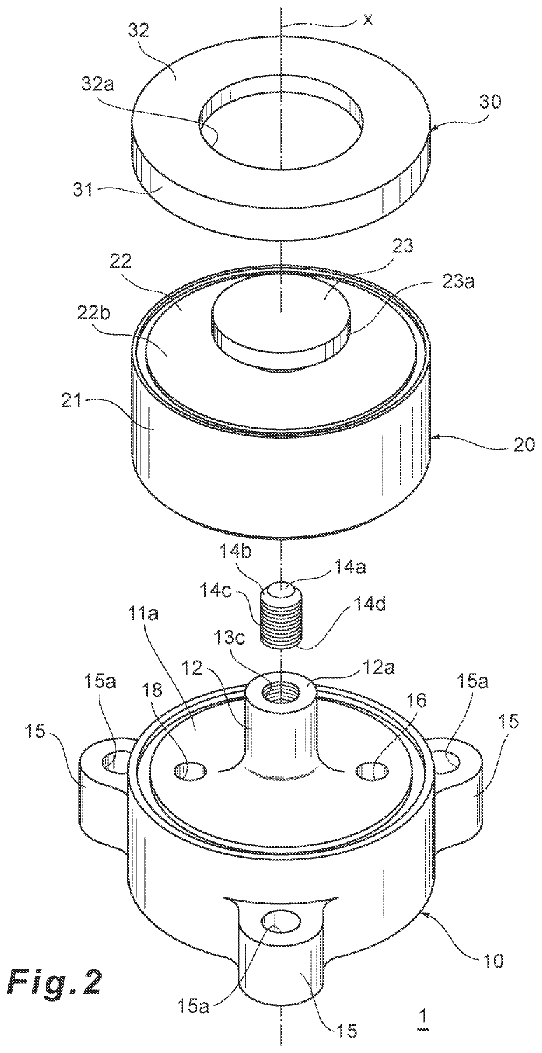

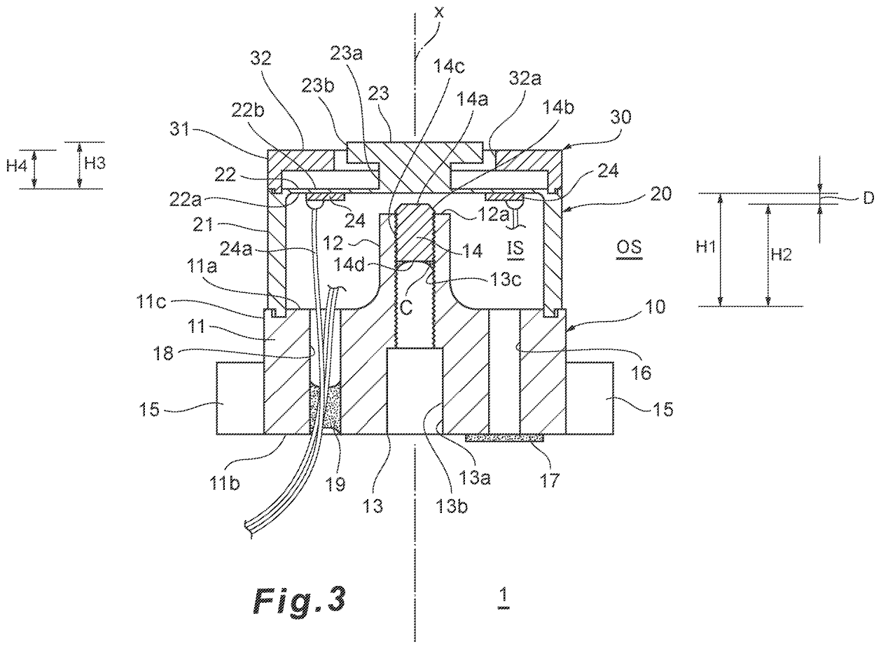

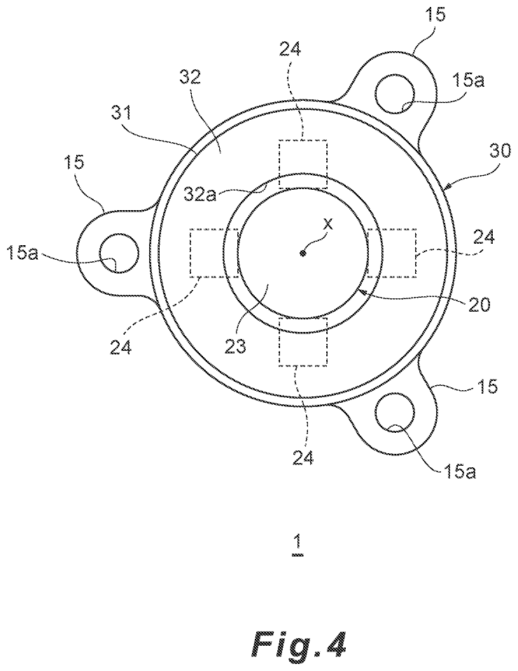

One embodiment of the present disclosure will be described below with reference to the attached drawings. FIG. 1 is a perspective view schematically illustrating the structure of the load detector 1 according to the first embodiment of the present disclosure. FIG. 2 is an exploded perspective view schematically illustrating the structure of the load detector 1. FIG. 3 is a cross-sectional view along the line 3-3 of FIG. 1. And FIG. 4 is a plan view schematically illustrating the structure of the load detector 1.

This load detector 1 is a load cell converting a load into an electrical signal. The load detector 1 is, for example, built into a device used in human surgery. Specifically, for example, the load detector 1 is attached to a circulation path for fluid to circulate as required during human surgery and functions to detect the pressure of the fluid in the circulation path. However, this application is an example, and the load detector 1 according to the present disclosure can also be used for any other application.

With reference to FIGS. 1 to 4 together, in the present embodiment, the load detector 1 is as a whole formed, for example, in a columnar shape. This load detector 1 includes a base part 10 arranged at the bottom side along the axis line x of the load detector 1, a flexure element 20 arranged at the upper side of the base part 10, and a cover 30 arranged at the upper side of the flexure element 20. In the description herein, the upper side and the bottom side do not necessarily coincide with an up-and-down direction in the direction of gravity.

As illustrated in FIG. 2, the base part 10 and the flexure element 20 are formed in a cylindrical shape extending around, for example, an axis line x. On the other hand, the cover 30 is formed in a ring extending around the axis line x, for example. Further, as illustrated in FIG. 3, the bottom end of the flexure element 20 is open, and as a result, an internal space IS of the load detector 1 is defined between the base part 10 and the flexure element 20. On the other hand, an external space OS of the load detector 1 is defined outside the base part 10 and the flexure element 20.

The base part 10 includes a columnar base body 11, for example, along the axis line x, and a columnar protrusion 12, for example, protruding upward from an upper surface 11a of the base body 11. The diameter of the base body 11 defined in the direction orthogonal to the axis line x is set to be larger than the diameter of a protrusion 12. The upper surface 11a of the base body 11 extends, for example, annularly around the protrusion 12, along a virtual plane orthogonal to the axis line x. A bottom surface 11b of the base body 11 extends in a circular shape along a virtual plane orthogonal to the axis line x, for example, parallel to the upper surface 11a. The upper surface 11a and the bottom surface 11b are connected to each other by a cylindrical outer peripheral surface 11c.

A through hole 13 is formed along the axis line x at the base body 11 and the protrusion 12. A through hole 13 penetrates from the bottom surface 11b of the base body 11 to a top end 12a of the protrusion 12. The through hole 13 connects the internal space IS and the external space OS to each other. The through hole 13 defines, for example, a cylindrical inner peripheral surface 13a. The inner peripheral surface 13a defines a large diameter part 13b opening at the bottom surface 11b of the base body 11 and a small diameter part 13c opening at the top end 12a of the protrusion 12. The diameter of the large diameter part 13b defined in the direction orthogonal to the axis line x is set larger than the diameter of the small diameter part 13c. The small diameter part 13c is female threaded.

Within the through hole 13, the stopper part 14 is supported at the top end of the through hole 13. At least a part of the stopper part 14 protrudes from the through hole 13 into the internal space IS. The through hole 13 is blocked by the stopper part 14. The stopper part 14 is formed, for example, in a columnar shape. An upper end surface 14a of the stopper part 14 extends along a virtual plane orthogonal to the axis line x, for example. A chamfer 14b may be formed at the corner of the upper end surface 14a. An outer peripheral surface 14c of the stopper part 14 is male threaded. The male screw is engaged with the female screw of the through hole 13.

At least a part of a bottom end surface 14d of the stopper part 14 is covered with a covering material C. In the present example, the covering material C is, for example, an adhesive, and the stopper part 14 is fixed in place at the through hole 13 by the covering material C. In the present example, the covering material C is interposed between the stopper part 14 and the through hole 13 along the entire periphery of the bottom end surface 14d of the stopper part 14, as illustrated in FIG. 3. Thus, since the covering material C is interposed between the stopper part 14 and the through hole 13, the stopper part 14 can be securely fixed in the through hole 13 and the through hole 13 can be securely sealed. Water and dust can be prevented from entering the internal space IS from the through hole 13.

At the bottom end surface 14d of the stopper part 14, for example, a drive part (not illustrated) for the tip of a driver tool to engage is formed. As described below, a driver tool (not illustrated) can be inserted into the through hole 13 of the base body 11 from the bottom surface 11b side of the base body 11. When the load detector 1 is assembled, the stopper part 14 is rotated around the axis line x by the driver tool so that the stopper part 14 can be displaced up and down along the axis line x.

At the outer peripheral surface 11c of the base body 11, for example, more than one, here three, attachment parts 15 protruding radially outward from the bottom end of the outer peripheral surface 11c are formed. The attachment parts 15 are evenly spaced around the axis line x at angular intervals of, for example, 120 degrees, as illustrated in FIG. 4. In each attachment part 15, a through hole 15a is formed parallel to the axis line x through the attachment part 15. A fixing member (e.g., screw, not illustrated) for attaching the load detector 1 to an external member not illustrated can be inserted into the through hole 15a. The load detector 1 is attached to the external member by, for example, screwing the fixing member via the through hole 15a to the external member.

As a variation of the attachment part 15, the inner peripheral surface of the through hole 15a may be female threaded. In this case, the load detector 1 may be attached to the external member by screwing the fixing member (e.g., screw) via the through hole formed at the external member, into the through hole 15a. This method of attaching the load detector 1 is an example, and the load detector 1 may be attached to an external member by another attaching method.

The flexure element 20 includes, for example, a cylindrical support part 21 extending around the axis line x, a circular flexure part 22 extending along a virtual plane orthogonal to the axis line x at the top end of the support part 21, and a load point 23 extending upward from the flexure part 22 along the axis line x. The bottom end of the support part 21 is supported by the upper surface 11a of the base body 11. The bottom end of the support part 21 is fixed to the base body 11 by, for example, an adhesive or welding, or the like (not illustrated). The flexure part 22 is, for example, at the outer periphery of the flexure part 22, entirely supported by the support part 21. The flexure part 22 is a thin plate and can be deformed by the action of an external force, i.e., a load.

An inner surface 22a of the flexure part 22 faces the upper end surface 14a of the stopper part 14, with the inner surface 22a facing away from the load point 23. That is, a height H1 from the upper surface 11a of the base body 11 to the inner surface 22a of the flexure part 22 is set to be greater than a height H2 from the same upper surface 11a to the upper end surface 14a of the stopper part 14. Thus, a predetermined distance D is set between the upper end surface 14a of the stopper part 14 and the inner surface 22a of the flexure part 22. As described below, this distance D can be adjusted by displacing the stopper part 14 up and down along the axis line X.

The load point 23 includes a small diameter part 23a formed at an outer surface 22b of the flexure part 22 and a large diameter part 23b arranged upward of the small diameter part 23a. The diameter of the large diameter part 23b orthogonal to the axis line x is set larger than the diameter of the small diameter part 23a. The small diameter part 23a and the large diameter part 23b are formed in a cylindrical shape around the axis line x. The small diameter part 23a and the large diameter part 23b are integrally formed. In the load detector 1, the flexure part 22 is deformed by the load acting on the load point 23.

As illustrated in FIGS. 3 and 4, at least one strain gauge 24 is attached to the inner surface 22a of the flexure part 22. For example, an adhesive (not illustrated) is used for attaching. In the present embodiment, four strain gauges 24 are evenly spaced around the axis line x at the inner surface 22a at angular intervals of, for example, 90 degrees. That is, the strain gauge 24 is placed, in plan view of the flexure part 22, at a position surrounding the inner surface 22a facing away from the small diameter part 23a of the load point 23. The number of the strain gauges 24 may be other than four. When the number of the strain gauges 24 is one, the strain gauge 24 needs only be attached around the inner surface 22a facing away from the small diameter part 23a of the load point 23. When the number of the strain gauges 24 is more than one, the strain gauges 24 need only be attached at equal angular intervals around the axis line x of the inner surface 22a.

For the strain gauge 24, for example, a resistor formed from a thin metal resistance foil is used. Current is supplied to the strain gauge 24 by a wiring 24a. When a load acts on the load point 23 and deforms the flexure part 22, the electrical resistance of the strain gauge 24 changes. This change in electrical resistance measures the amount of deformation, or the magnitude of the load.

The cover 30 includes, for example, a flat cylindrical outer circumferential part 31 extending around the axis line x, and an annular part 32 extending radially inward from the top end of the outer circumferential part 31, for example, in a disk shape. The outer circumferential part 31 is supported by the top end of the support part 21 of the flexure element 20 at the open bottom end of this outer circumferential part 31. The bottom end of the outer circumferential part 31 is fixed to the support part 21 of the flexure element 20 with, for example, an adhesive. The annular part 32 extends along a virtual plane orthogonal to the axis line x. The annular part 32 covers at least a partial area of the flexure part 22 around the load point 23.

At the annular part 32, a circular through hole 32a is formed to extend around the axis line x. The large diameter part 23b of the load point 23 is placed in the through hole 32a. Thus, the outer circumferential part 31 of the cover 30 can prevent the load from acting on the load point 23 in the radial direction orthogonal to the axis line x. Additionally, the annular part 32 can receive the load in the direction along the axis line x. As a result, in the direction along the axis line x, it is possible to prevent the load from acting on the flexure part 22 from other than the load point 23.

The inner peripheral surface of the through hole 32a is radially opposed to the outer peripheral surface of the large diameter part 23b of the load point 23. That is, a predetermined gap is defined between the inner peripheral surface of the through hole 32a and the outer peripheral surface of the large diameter part 23b. Further, a height H3 of the load point 23 from the outer surface 22b of the flexure part 22 is set larger than a height H4 of the annular part 32 from the same outer surface 22b. With such a configuration, the load can reliably act on the load point 23.

As illustrated in FIGS. 3 and 4, the base part 10 includes an air vent 16 penetrating the base body 11. In the present embodiment, the air vent 16 penetrates from the upper surface 11a of the base body 11 to the bottom surface 11b parallel to the axis line x, for example. Thus, the air vent 16 connects the internal space IS and the external space OS of the load detector 1 to each other. The air vent 16 is blocked by a ventilating material 17 at the bottom surface 11b of the base body 11, for example. The ventilating material 17 is attached to the bottom surface 11b of the base body 11, for example.

The ventilating material 17 is formed from a breathable and waterproof filter. The ventilating material 17 is formed from a resin material such as, for example, polytetrafluoroethylene (PTFE). The resin material includes, for example, innumerable micropores. The micropores block the passage of water and dust while allowing air to pass through. With such a configuration, the internal space IS of the load detector 1 can maintain the same air pressure, temperature, and other conditions as the external space OS.

The base part 10 further includes a wiring hole 18 through the base body 11. In the present embodiment, the wiring hole 18 penetrates from the upper surface 11a of the base body 11 to the bottom surface 11b parallel to the axis line x, for example, in the same manner as the air vent 16. Thus, the wiring hole 18 connects the internal space IS and the external space OS of the load detector 1 to each other. The wiring hole 18 is a hole allowing the wiring 24a of each strain gauge 24 to pass inside. Through the wiring hole 18, the wiring 24a is drawn to the external space OS. With this wiring 24a, the resistance change of the strain gauge 24 is output to an external device (not illustrated) or the like.

The wiring hole 18 is sealed with a seal 19. For the seal 19, for example, an epoxy-based resin material is used. During assembly of the load detector 1, after all wirings 24a are passed through the wiring hole 18, the molten resin material is poured into the wiring hole 18. The molten resin material then hardens to form the seal 19 in the wiring hole 18. According to the seal 19, water and dust can be prevented from entering the internal space IS through the wiring hole 18.

Next, the usage of the load detector 1 is described below. As described above, the load detector 1 is used while attached to an external member (not illustrated). In one example, the upper surface of the large diameter part 23b of the load point 23 is used in contact with the circulation path for the liquid (not illustrated). The load detector 1 may be arranged so that the axis line x coincides with the vertical direction, or so that the axis line x is orthogonal to the vertical direction.

The load acting on the load point 23 from the liquid in the circulation path displaces the load point 23 downward along the axis line x. When the flexure part 22 is deformed by this displacement, the electrical resistance of the strain gauge 24 attached to the inner surface 22a of the flexure part 22 changes. This change in electrical resistance is output to an external device through the wiring 24a. Based on the change in the output electrical resistance, the load applied to the load point 23 is measured.

During measurement of this load, when a large load, such as an overload, acts on the load point 23, the flexure part 22 will try to deform greatly. At this time, the inner surface 22a of the flexure part 22 is received by the upper end surface 14a of the stopper part 14. Further deformation of the flexure part 22 is prevented. In this way, excessive deformation of the flexure part 22 is prevented, so that damage to the flexure part 22 can be prevented. The inner surface 22a of the flexure part 22 and the upper end surface 14a of the stopper part 14 are separated by the distance D. Thus, the maximum amount of deformation of the flexure part 22 can be set by setting this distance D.

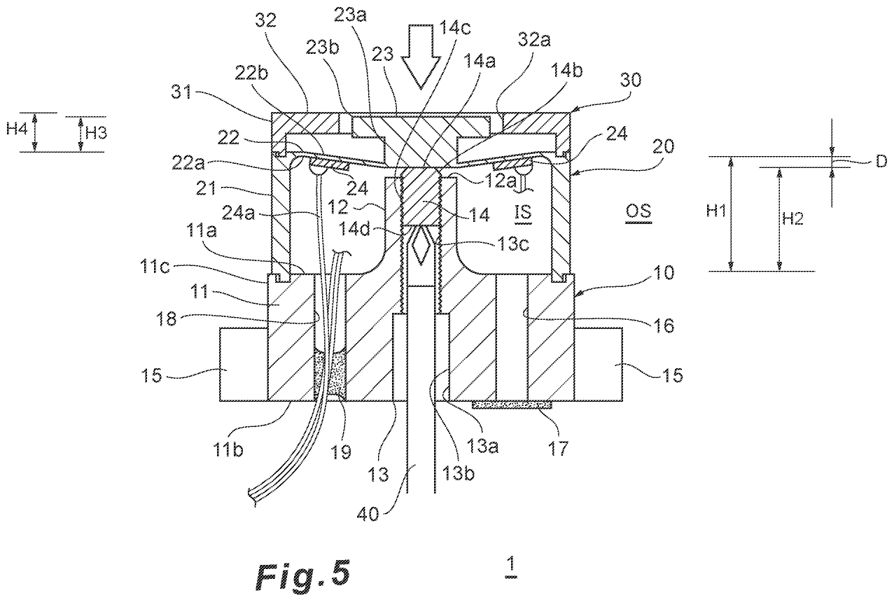

The distance D is adjusted, for example, during assembly of the load detector 1. Specifically, the flexure part 22 is deformed by applying a load, to the load point 23, to match the maximum load allowable for the load detector 1 without the stopper part 14 being located in the through hole 13 of the base part 10. The output of the strain gauge 24 at this time is confirmed. With the flexure part 22 still deformed, the stopper part 14 is placed in the through hole 13 of the base part 10. As illustrated in FIG. 5, the tip of a driver tool 40 is engaged with the drive part of the bottom end surface 14d of the stopper part 14, and the stopper part 14 is turned around the axis line x. The stopper part 14 is displaced upward along the axis line x.

The stopper part 14 is then displaced upward along the axis line x until the upper end surface 14a of the stopper part 14 contacts the inner surface 22a of the flexure part 22 with the maximum load applied. When the upper end surface 14a of the stopper part 14 contacts the inner surface 22a, the load on the load point 23 is released. Between the stopper part 14 and the through hole 13, covering material C, or adhesive, is applied from the through hole 13 to the bottom end surface 14d of the stopper part 14. The stopper part 14 is thus fixed within the through hole 13. After curing the adhesive, a load greater than the maximum allowable load is applied to the load point 23. At this time, when the output of the strain gauge 24 is confirmed to match the maximum allowable load, the setting of the distance D is completed.

In the above example, the adjustment of the distance D is started when the stopper part 14 is not placed in the through hole 13 of the base part 10, but the stopper part 14 may be placed in the through hole 13 in advance. For example, the stopper part 14 may be screwed into the through hole 13 of the base part 10 before the flexure element 20 is attached to the base part 10. Then the flexure element 20 is fixed to the base part 10. At this time, sufficient distance D is ensured between the upper end surface 14a of the stopper part 14 and the inner surface 22a of the flexure part 22. Then the distance D is set as in the above example.

In the load detector 1 as described above, the base part 10, the flexure element 20 and the cover 30 are all formed from a metallic material, for example. In the present embodiment, at the flexure element 20, the support part 21, the flexure part 22 and the load point 23 are formed integrally from the same metallic material. However, the support part 21, the flexure part 22 and the load point 23 may be formed separately, for example, and only the flexure part 22 and the load point 23 may be formed integrally. The metallic materials forming the flexure element 20 include, for example, nickel-chrome-molybdenum steel, stainless steel, aluminum alloy, and the like.

It is particularly preferable that at least the flexure part 22 and the stopper part 14 are formed from the same metallic material. That is, the stopper part 14 is also formed from a metallic material such as, for example, nickel-chrome-molybdenum steel, stainless steel, aluminum alloy, or the like. When the load detector 1 is used, repeated contact between the inner surface 22a of the flexure part 22 and the upper end surface 14a of the stopper part 14 causes wear of the flexure part 22 or the stopper part 14 over time and increases the distance D. However, when the flexure part 22 and the stopper part 14 are formed from the same metal material, wear can be suppressed as much as possible compared to when formed from different metal materials. Consequently, by forming the flexure part 22 and the stopper part 14 from the same metal material, the life of the load detector 1 can be extended.

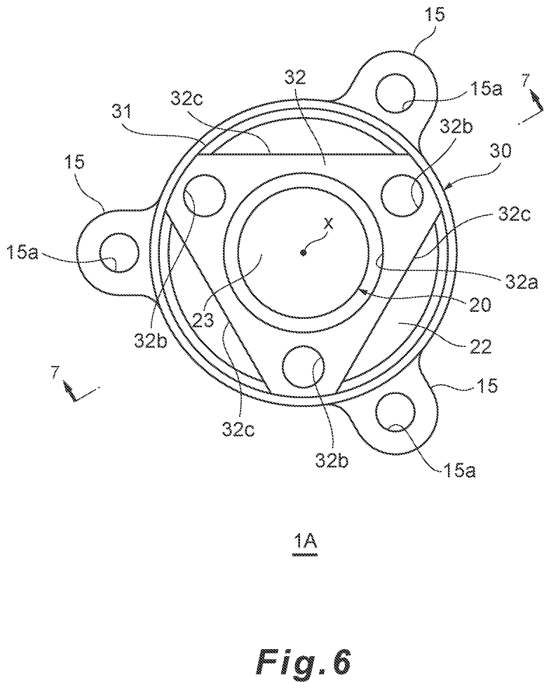

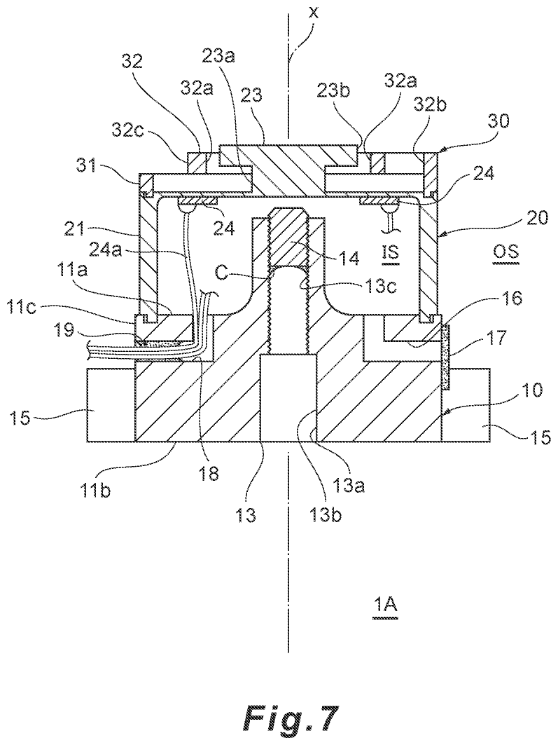

FIG. 6 is a plan view schematically illustrating the structure of the load detector 1A according to the second embodiment of the present disclosure, and FIG. 7 is a cross-sectional view of the load detector 1A along the line 7-7 of FIG. 6. In the load detector 1A according to the second embodiment, the same reference signs are attached to the same configuration as the configuration of the load detector 1 according to the first embodiment, and the overlapping explanation is omitted here. In this load detector 1A, a part of the configuration of the base part 10 and the cover 30 is different from the configuration of the load detector 1.

Referring to FIGS. 6 and 7 together, the air vent 16 formed at the base body 11 extends along the axis line x from the upper surface 11a of the base body 11 toward the bottom surface 11b, then bends outward in a radial direction orthogonal to the axis line x and finally extends to the outer peripheral surface 11c of the base body 11. The air vent 16 opening at the outer peripheral surface 11c is blocked by the ventilating material 17. For example, when the bottom surface 11b of the base body 11 abuts against an external member and the opening of the air vent 16 at the bottom surface 11b is blocked by the external member, the air vent 16 may open at the outer peripheral surface 11c of the base body 11 in this way. Such a configuration can also provide the same working effect as the configuration according to the first embodiment.

On the other hand, the wiring hole 18 formed at the base body 11 may likewise extend along the axis line x from the upper surface 11a of the base body 11 toward the bottom surface 11b, then bend outward in a radial direction orthogonal to the axis line x, and finally extend to the outer peripheral surface 11c of the base body 11. The wiring hole 18 is sealed by the seal 19. For example, when the bottom surface 11b of the base body 11 abuts against an external member and the opening of the wiring hole 18 at the bottom surface 11b is blocked by the external member, the wiring hole 18 may open at the outer peripheral surface 11c of the base body 11 in this way. Such a configuration can also provide the same working effect as the configuration according to the first embodiment.

On the other hand, the cover 30 may have one or more first openings 32b and/or one or more second openings 32c arranged around the through hole 32a in addition to the through hole 32a. In the present embodiment, between the through hole 32a and the outer circumferential part 31, for example, three first openings 32b are evenly spaced at angular intervals of 120 degrees around the axis line x. The first opening 32b penetrates the annular part 32 along the axis line x. In the plan view of FIG. 6, a first opening 32b is defined in a circular shape. For example, the diameter of the first opening 32b defined in the direction orthogonal to the axis line x is set to be smaller than the diameter of the through hole 32a defined in the direction orthogonal to the axis line x as well.

Additionally, in the present embodiment, between the through hole 32a and the outer circumferential part 31, for example, three second openings 32c are evenly spaced at angular intervals of 120 degrees around the axis line x. In the plan view of FIG. 6, the radial outer edge of each second opening 32c is defined in an arc shape by the outer circumferential part 31. On the other hand, the radial inner edge of each second opening 32c is defined in a linear shape. That is, the second opening 32c is defined in an arch shape. The second opening 32c penetrates the annular part 32 along the axis line x. Thus, the annular part 32 of the cover 30 is as a whole formed in a triangular shape in plan view.

According to the load detector 1A described above, the outer circumferential part 31 prevents the load from acting on the load point 23 in the radial direction orthogonal to the axis line x, similar to the load detector 1 according to the first embodiment. In addition, the annular part 32 can receive the load from the direction along the axis line x. Moreover, even when water or dust enters the space between the flexure part 22 and the cover 30 from the through hole 32a, for example, the water or dust can be discharged from the first opening 32b or the second opening 32c to the external space OS. The influence of water and dust on the deformation of the flexure part 22 can be avoided. In particular, when the load detector 1A is arranged so that the axis line x is orthogonal to the vertical direction, water and dust can be effectively discharged from the first opening 32b or the second opening 32c.

As a variation of the load detector 1, 1A described above, the stopper part 14 may be press-fitted into the through hole 13 instead of the engagement of a screw groove. Specifically, formation of the screw groove is omitted at the small diameter part 13c of the through hole 13 and the outer peripheral surface 14c of the stopper part 14. In addition, the diameter of the stopper part 14 is set larger than the diameter of the small diameter part 13c by the amount of interference. When the load detector 1, 1A is assembled, the stopper part 14 is press-fitted into the through hole 13. The position of the stopper part 14 along the axis line x is adjusted by the magnitude of the force applied during press-fitting. It is also possible to adjust the position or the distance D of the stopper part 14 by such methods.

Further, the area of the bottom end surface 14d of the stopper part 14 covered by the covering material C is not limited to the example described above. That is, the covering material C may directly cover at least a part of the outer periphery of the bottom end surface 14d of the stopper part 14. The covering material C may also directly cover the entire bottom end surface 14d as well as the outer periphery of the bottom end surface 14d. In this case, the space within the small diameter part 13c of the through hole 13 may be filled with the covering material C.

The covering material C may also cover the bottom end surface 14d of the stopper part 14 so as to cover the opening at the bottom surface 11b side of the large diameter part 13b of the through hole 13. In this case, the covering material C is not a flowable material such as an adhesive, but is formed from a film of a waterproof resin material, or the like. In addition, a spacer (not illustrated) may be interposed between the bottom end surface 14d of the stopper part 14 and the covering material C in order to prevent the stopper part 14 from moving along the axis line x. In this case, the upper end surface of the spacer may be shaped to fit into the drive part of the bottom end surface 14d of the stopper part 14. According to this kind of spacer, the rotation of the stopper part 14 around the axis line x is prevented by the covering material C and the spacer, thus preventing the movement of the stopper part 14 along the axis line x.

For example, a chamfer (not illustrated) may be formed at the corner of the bottom end surface 14d of the stopper part 14. In the present specification, the truncated conical surface formed by the chamfer is defined as a part of the bottom end surface 14d. In this case, the covering material C may be interposed in at least a part of the area between the bottom end surface 14d between the truncated conical surface formed by the chamfer and the inner peripheral surface 13a of the through hole 13. That is, the covering material C may cover the bottom end surface 14d over the entire truncated conical surface formed by the chamfer. In addition to the cases described above, the covering material C may be further filled between the inner peripheral surface 13a of the through hole 13 and the outer peripheral surface 14c of the stopper part 14. With this configuration, the stopper part 14 is more securely fixed in the through hole 13.

Furthermore, at the flexure element 20, the formation of the load point 23 may be omitted. That is, nothing is placed at the outer surface 22b of the flexure part 22 of the flexure element 20. Thus, the flexure part 22 is directly loaded from the subject contacting the flexure part 22 through the through hole 32a of the cover 30. Even in such a case, the annular part 32 of the cover 30 can function to receive the load in the direction along the axis line x. As a result, in the direction along the axis line x, it is possible to prevent the load from acting on the flexure part 22 from areas other than the area in the through hole 32a.

At the base part 10, the formation of the protrusion 12 may be omitted. In this case, the upper end surface 14a of the stopper part 14 may face the inner surface 22a of the flexure part 22 by increasing the length of the stopper part 14 along the axis line x. At the through hole 13, the arrangement of the large diameter part 13b and the small diameter part 13c may be replaced along the axis line x. That is, the stopper part 14 may be fixed within the large diameter part 13b located at the upper side along the axis line x. In addition, the through hole 13 may have a constant diameter.

Although the present disclosure has been described above through the above embodiments, the technical scope of the present disclosure is not limited to the scope described in the above embodiments. It will be apparent to those skilled in the art that various modifications or improvements can be made to the above embodiments. It is apparent from the description of the claims that the forms with such modifications or improvements may also be included in the technical scope of the present disclosure.

The above-described embodiments are intended to facilitate the understanding of the present disclosure and are not intended to be construed as limiting the disclosure. Each component and the arrangement, material, condition, shape, size, or the like of that component provided in the above embodiments are not limited to the contents exemplified and may be changed accordingly. In addition, to the extent of not being technically inconsistent, the components illustrated in different embodiments may be partially replaced or combined.

### REFERENCE SIGNS LIST

1, 1A Load detector, 10 Base part, 11 Base body, 11a Upper surface, 11b Bottom surface, 12 Protrusion, 12a Top end, 13 Through hole, 13a Inner peripheral surface, 13b Large diameter part, 13c Small diameter part, 14 Stopper part, 14a Upper end surface, 14b Chamfer 14c Outer peripheral surface, 14d Bottom end surface, 15 Attachment part, 15a Through hole 16 Air vent, 17 Ventilating material, 18 Wiring hole, 19 Seal, 20 Flexure element, 21 Support part, 22 Flexure part, 22a Inner surface, 22b Outer surface, 23 Load point, 23a Small diameter part, 23b Large diameter part, 24 Strain gauge, 24a Wiring, 30 Cover, 31 Outer circumferential part, 32 Annular part, 32a Through hole, 32b First opening, 32c Second opening, C Covering material, D Distance, H1 Height, H2 Height, H3 Height, H4 Height, IS Internal space, OS External space, x Axis line

1. A load detector, comprising:
a flexure element;
a base part supporting the flexure element;
at least one strain gauge attached to an inner surface of a flexure part constituting the flexure element; and
a stopper part attached to the base part, receiving the inner surface of the flexure part when the flexure part is deformed, and regulating the deformation of the flexure part, wherein
a distance between the stopper part and the inner surface of the flexure part is adjustable.

2. The load detector according to claim 1, wherein
the base part includes a through hole connecting an internal space and an external space, the internal space being formed between the flexure element and the base part, and
the stopper part is supported within the through hole.

3. The load detector according to claim 2, wherein
the stopper part includes a male screw at an outer peripheral surface of the stopper part,
the through hole includes a female screw at an inner peripheral surface of the through hole, and
the distance is adjusted by turning the stopper part via the through hole.

4. The load detector according to claim 1, further comprising:
a cover attached to the flexure element and formed including at least one opening, wherein
the cover covers at least a part of an outer surface of the flexure part.

5. The load detector according to claim 4, further comprising:
a load point bearing a load and located at the outer surface of the flexure part, wherein
the cover covers the outer surface of the flexure part around the load point.

6. The load detector according to claim 5, wherein
the stopper part faces the inner surface of the flexure part, the inner surface facing away from the load point of the flexure part.

7. The load detector according to claim 5, wherein
at least two of the strain gauges are attached at positions surrounding the inner surface facing away from the load point.

8. The load detector according to claim 5, wherein
a height of the load point from the outer surface of the flexure part is set to be greater than a height of the cover from the outer surface of the flexure part.

9. The load detector according to claim 1, wherein
an end face at the external space side of the stopper part is at least partially covered by a covering material.

10. The load detector according to claim 1, wherein
the base part includes an air vent connecting an internal space and an external space, the internal space being formed between the flexure element and the base part, and
the air vent is blocked with a ventilating material, the ventilating material being breathable and waterproof.

11. The load detector according to claim 1, wherein
the base part includes a wiring hole for drawing a wiring of the strain gauge to the external space, and
the wiring hole is sealed with a seal.

12. The load detector according to claim 1, wherein
the base part includes an attachment part for attaching the load detector to an external member, and
the attachment part includes a through hole allowing insertion of a fixing member, the fixing member being fixed to the external member.

13. A load detector, comprising:
a flexure element;
a base part supporting the flexure element; and
at least one strain gauge attached to an inner surface of a flexure part constituting the flexure element, wherein
the base part includes an air vent connecting an internal space and an external space, the internal space being formed between the flexure element and the base part, and
the air vent is blocked with a ventilating material, the ventilating material being breathable and waterproof.

14. The load detector according to claim 13, further comprising
a stopper part attached to the base part, receiving the inner surface of the flexure part when the flexure part is deformed, and regulating the deformation of the flexure part, wherein
a distance between the stopper part and the inner surface of the flexure part is adjustable.

15. The load detector according to claim 14, wherein
the base part includes a through hole connecting the internal space formed between the flexure element and the base part, and the external space, and
the stopper part is supported within the through hole.

16. The load detector according to claim 15, wherein
the stopper part includes a male screw at an outer peripheral surface of the stopper part,
the through hole includes a female screw at an inner peripheral surface of the through hole, and
the distance is adjusted by turning the stopper part via the through hole.

17. The load detector according to claim 13, further comprising:
a cover attached to the flexure element and formed including at least one opening, wherein
the cover covers at least a part of an outer surface of the flexure part.

18. The load detector according to claim 17, further comprising:
a load point bearing a load and located at the outer surface of the flexure part, wherein
the cover covers the outer surface of the flexure part around the load point.

19. The load detector according to claim 18, wherein
the stopper part faces the inner surface of the flexure part, the inner surface facing away from the load point of the flexure part.

20. The load detector according to claim 18, wherein
at least two of the strain gauges are attached at positions surrounding the inner surface facing away from the load point.

21. The load detector according to claim 18, wherein
a height of the load point from the outer surface of the flexure part is set to be greater than a height of the cover from the outer surface of the flexure part.

22. The load detector according to claim 13, wherein
an end face at the external space side of the stopper part is at least partially covered by a covering material.

23. The load detector according to claim 13, wherein
the base part includes a wiring hole for drawing a wiring of the strain gauge to the external space, and
the wiring hole is sealed with a seal.

24. The load detector according to claim 13, wherein
the base part includes an attachment part for attaching the load detector to an external member, and
the attachment part includes a through hole allowing insertion of a fixing member, the fixing member being fixed to the external member.
